(19) United States
(12) Patent Application Publication
(10) Pub. No.: US 2018/0100468 A1
(43) Pub. Date: Apr. 12, 2018

(54) SYSTEM AND METHOD FOR REDUCTION OF TURBINE EXHAUST GAS IMPINGEMENT ON ADJACENT AIRCRAFT STRUCTURE

(71) Applicant: Rolls-Royce North American Technologies Inc., Indianapolis, IN (US)

(72) Inventors: David Levi Sutterfield, Greenwood, IN (US); Anthony Frank Pierluissi, Fishers, IN (US); Bryan Henry Lerg, Carmel, IN (US)

(73) Assignee: Rolls-Royce North American Technologies Inc., Indianapolis, IN (US)

(21) Appl. No.: 15/288,303

(22) Filed: Oct. 7, 2016

(51) Int. Cl. F02K 1/82; F01D 25/30; B64D 33/04

(52) U.S. Cl. CPC F02K 1/82; F05D 2220/323; B64D 33/04; F01D 25/30

(57) ABSTRACT

Systems and methods for the protection of a surface adjacent to an exhaust system are presented herein. The system may comprise an ejector, an ejector inlet, and a ejector shroud, and a shroud outlet. The ejector may include the exhaust nozzle of an engine. The should outlet is in fluid communication with the atmosphere. The adjacent surface may partially bound a region proximate to and downstream of the shroud outlet. The system may further comprise a plurality of forced mixing lobes that extend from the engine exhaust nozzle in a region spaced apart from the adjacent surface. The distribution of the lobes may be asymmetric in the cross section of the ejector shroud proximate to the shroud outlet.

### BACKGROUND

Current exhaust systems for turboprop and turboshaft gas turbine engines dump the exhaust gas just outside of the aircraft body allowing the hot gas to imping or “scrub” the downstream aircraft parts (wing, tail, nacelle, etc.) potentially causing damage or early wear to these parts.

The exhaust nozzle and plume from gas turbine engines, along with heated adjacent surfaces are also a potentially large source of infrared energy which may be used for targeting and/or tracking purposes. More specifically, the infrared energy may be used for targeting and/or tracking by heat seeking missiles and/or various forms of infrared imaging systems. Because the military mission of helicopters, turboprop cargo planes and other aircraft may involve flying at lower altitudes and at reduced speed in comparison to other high-performance military aircrafts, helicopters and turboprop planes are more susceptible to ground-to-air, infrared-guided missiles. For example, within at least some known helicopters, the exposed metal surfaces of the gas turbine engine exhaust may operate in excess of 800 degrees Fahrenheit, and thus emit strongly across many wavelengths of the electromagnetic spectrum including virtually all infrared wavelengths from 700 nm to 1 mm as hot exhaust gases flow past the exposed surfaces. Moreover, continued heating of aircraft surfaces, including the fuselage, during hover or flight may also create structural issues.

In order to prevent unwanted heating of aircraft surfaces and underlying structures, aircraft and power plant designers often include protective devices, such as heat shields, proximate to the aircraft exhaust as shown in FIG. 1a. In FIG. 1a, the exposed surface 17 adjacent to the turbine exhaust nozzle 18 of the gas turbine 10 is typically shielded by an exhaust deflector 13, heat resistant paint [not shown] and insulating panels 19. The addition of these protective devices results in decreased aircraft performance due to increased weight and aerodynamic drag and leads to increased costs. These protective devices are located aft of the exhaust outlet along an area exposed to the exhaust gas.

In addition, conventional exhaust systems attempt to cool the exhaust gas. FIG. 1b shows an ejector system used to cool the exhaust gas in conventional systems. The core exhaust nozzle 12 directs the exhaust gas into an ejector shroud 16 and the nozzle 12 and ejector shroud 16 form a secondary flow inlet 20. The secondary flow, typically entrained air or system cooling air is introduced and mixed symmetrically with the exhaust gases without consideration of its location to the adjacent aircraft surfaces. The addition of the cooling air reduces some of the deleterious effects described above but does not prevent the impingement on and subsequent scrubbing and heating of the adjacent surfaces.

In order to obviate the above described deleterious effects, the disclosed exhaust system utilizes a combination of exhaust shaping, secondary flow injection and mixing to cause the exhaust gas to exit the nozzle at an angle that prevents the hot gas from “scrubbing” the downstream aircraft parts and prevents or reduces damage to these parts.

### BRIEF SUMMARY OF THE CLAIMS AS ORIGINALLY FILED

An exhaust system for the protection of an adjacent surface is presented herein. The exhaust system having an ejector with an engine exhaust nozzle, an ejector inlet, an ejector shroud and a shroud outlet. The shroud outlet releases the exhaust gas into the ambient air. In the system, the adjacent surface partially bounds the region proximate and downstream of the shroud outlet, the system having a plurality of forced mixing lobes extending from the engine exhaust nozzle within a region that is on the opposite side of the adjacent surface resulting in a distribution of lobes that is asymmetric in the cross section of the ejector shroud proximate the shroud outlet.

The disclosed subject matter, among others, includes a turbine engine core exhaust system with a core exhaust duct, a secondary air inlet and a duct having a passage having an upstream end, a downstream end, as well as a first portion and a second portion. The upstream end of the duct is proximate to the core exhaust duct and defines the secondary air inlet, where the first and second portions are proximate the downstream end. The system also includes a surface disruption in an interior of the first portion extending into the passage towards the second portion, where the second portion is free from the surface disruption in the first portion.

The disclosed subject matter further, among others, includes a method of bending an exhaust flow away from an adjacent surface. The method includes a core exhaust flow within a passage, the passage having one side closer to the adjacent surface than the other side of the passage and a secondary flow between the other side of the passage and the core exhaust flow, wherein the core exhaust flow has a higher velocity than the secondary flow. The method includes the step of reducing the velocity of the core exhaust flow that is near the other side by mixing the core exhaust flow and the secondary flow within the passage proximate the other side of the passage; and, maintaining the velocity of the core exhaust flow that is near the one side at a velocity more than the reduced velocity on the other side thereby bending the exhaust flow away from the adjacent surface.

### BRIEF DESCRIPTION OF THE DRAWINGS

Preferred embodiments according to the present subject matter will now be described with reference to the Figures, in which like reference numerals denote like elements.

The following will be apparent from elements of the figures, which are provided for illustrative purposes and are not necessarily to scale.

FIGS. 1a and 1b illustrate a prior art conventional exhaust system.

FIG. 2 illustrates an exhaust system according to an embodiment of the disclosed subject matter.

FIG. 3 illustrates an fuselage concept exhaust system according to an additional embodiment of the disclosed subject matter.

FIGS. 4a-4d illustrate axial cross sections according to embodiments of the disclosed subject matter.

FIGS. 5a-5c illustrate exhaust shroud exits and lobes according to embodiments of the disclosed subject matter.

FIG. 6 illustrates an underwing concept exhaust system according to an embodiment of the disclosed subject matter.

FIG. 7 is a flow chart for a method of bending an exhaust flow away from an adjacent surface according to an embodiment of the disclosed subject matter.

FIGS. 8a and 8b illustrate the plurality of lobes on the exit of a rectangular exhaust duct according to an embodiment of the disclosed subject matter.

FIGS. 9a and 9b illustrate the plurality of lobes on the exit of a circular exhaust duct according to an embodiment of the disclosed subject matter.

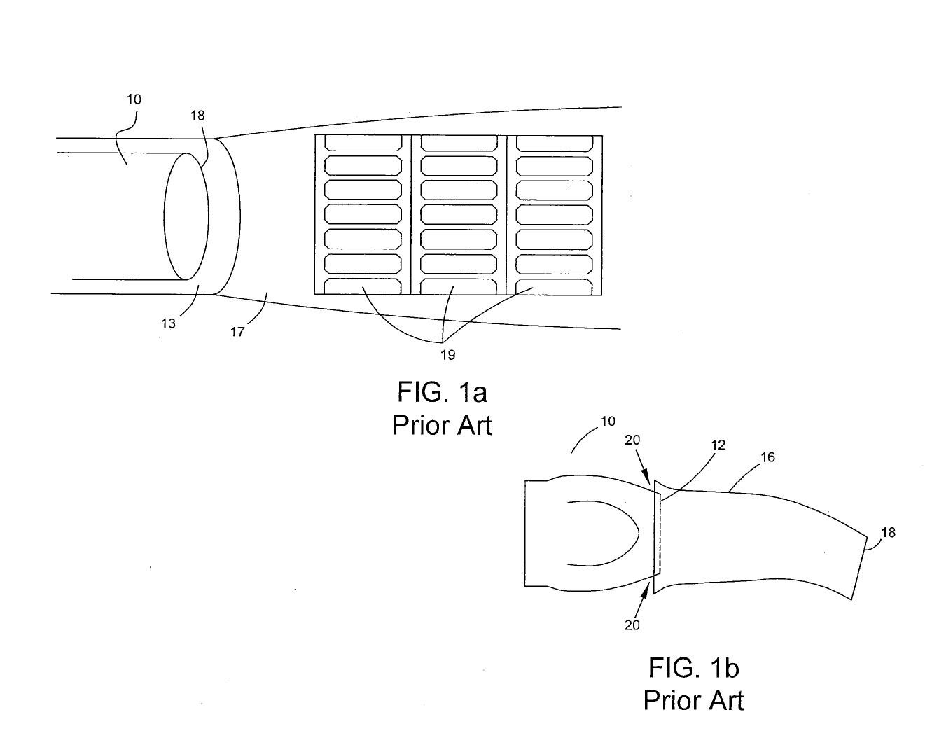

While the present disclosure is susceptible to various modifications and alternative forms, specific embodiments have been shown by way of example in the drawings and will be described in detail herein. It should be understood, however, that the present disclosure is not intended to be limited to the particular forms disclosed. Rather, the present disclosure is to cover all modifications, equivalents, and alternatives falling within the spirit and scope of the disclosure as defined by the appended claims.

### DETAILED DESCRIPTION

For the purposes of promoting an understanding of the principles of the disclosure, reference will now be made to a number of illustrative embodiments illustrated in the drawings and specific language will be used to describe the same.

The proposed exhaust system utilizes exhaust shaping and fluid dynamics to cool the exhaust gas and direct it away from the aircraft structure. Secondary inlets are used to provide the cooling air and to form cooling layers on adjacent aircraft structure.

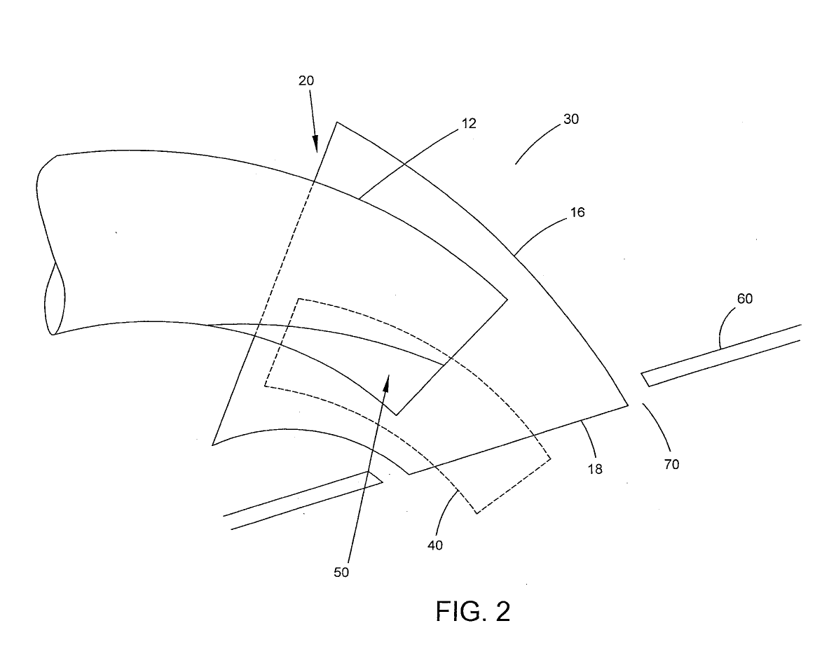

FIG. 2 describes an embodiment of the disclosed subject matter. As illustrated in FIG. 2, an ejector 30 is formed from the turbine core exhaust nozzle 12 and an ejector shroud 16 having secondary flow inlet 20. The inlet 20 in the embodiment shown circumscribes the turbine core exhaust nozzle 12, however other embodiments may not be so limited. Engine exhaust gasses flowing through core exhaust nozzle 12 (primary flow area) in the ejector 30 serve as the motive fluid, passing through the ejector shroud 16 to form a low pressure area that creates suction or viscous draw on the secondary flow introduced through the ejector inlet 20. As shown in FIG. 2, the turbine core exhaust nozzle 12 incorporates a plurality of forced mixing lobes 50 that extend from the engine exhaust nozzle 12 into a region 40 within the ejector shroud 16. The region is spaced apart from the adjacent surface 60. The distribution of the forced mixing lobes 50 is asymmetric in the cross section of the ejector shroud 16 proximate the ejector shroud outlet 18, such that lobes 50 are only placed in the region farthest away from the adjacent surface 60 and the area of the shroud outlet 18 closest to the adjacent surface 60 is free from lobes 50 as shown in FIG. 2, or the numbers and/or size are greatest in that region.

Also shown in FIG. 2 is an auxiliary outlet 70 is positioned between the ejector shroud outlet 18 and the adjacent surface 60. The air flow supplied to the auxiliary outlet 70 may be entrained air or cooling air from another compartment. The auxiliary outlet 70 maintains a layer of cooler air between the adjacent surface 60 and the exhaust plume. FIG. 2 shows that the fluid path through the exhaust system has a centerline that bends away from the adjacent surface 60 to further urge the flow away from the adjacent surface 60.

The plurality of lobes 50 forces mixing of the secondary and core exhaust flows which slows the velocity of the combined flow as it is exhausted. This asymmetric mixing and slowing of the flow urges the combined exhaust flow in the direction of the lobes and away from the adjacent surface 60. The adjacent surface 60 may be a nacelle, fuselage, wing, flap, tail or other aircraft structure positioned proximate the ejector shroud outlet 18 which would be impinged upon but for the described subject matter.

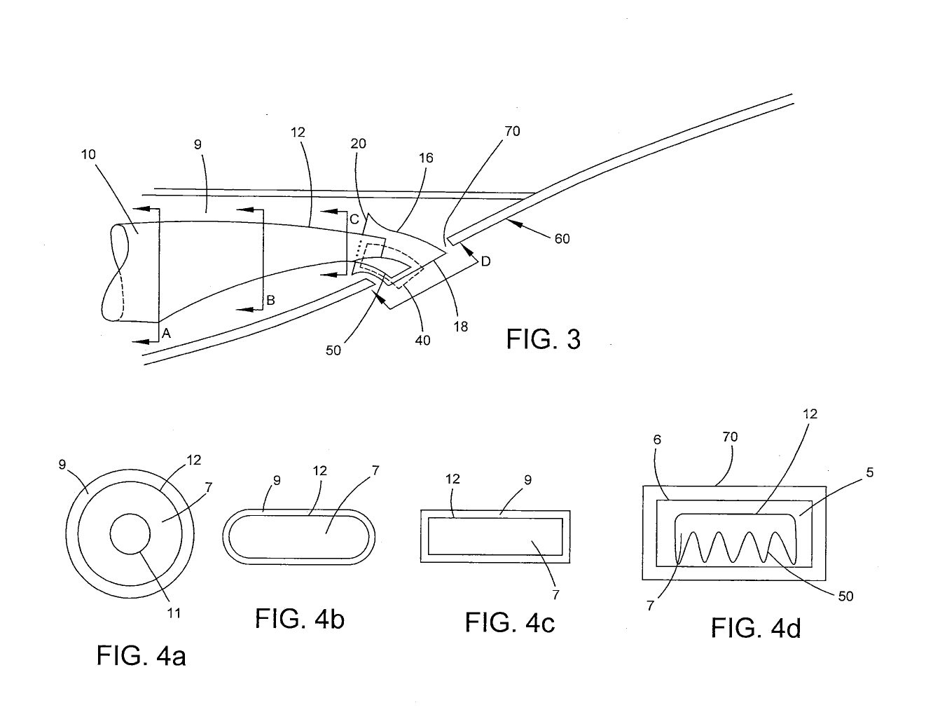

FIG. 3 illustrates a disclosed exhaust system used with a turbine engine 10 within an aircraft fuselage with the exhaust being directed down and aft from the adjacent surface 60. In the embodiment shown in FIG. 3, the plurality of lobes 50 extend into region 40 well beyond the core exhaust nozzle 12. FIGS. 4a-4d show the cross section of the exhaust nozzle 12, ejector shroud 16 and ejector exhaust outlet 18 with respect to stream positions A, B, C and D as shown in FIG. 3. In a preferred embodiment the flow paths transition from a round cross-section as the flow exits the gas turbine 10, shown in FIG. 4a, to rectangular or square when exiting the ejector shroud 16, as shown in FIG. 4d.

FIG. 4a shows a cross section of the exhaust nozzle 12 and center cone 11 at stream position A (i.e., as taken along the line ‘A’) of FIG. 3. The core exhaust passage 7 exiting the turbine 10 has a round shape corresponding to the turbine outlet (not shown). The secondary air passage 9 is also shown as round however its shape at this station is more dependent upon the shape of the fuselage (not shown) or nacelle (not shown) than the turbine outlet (not shown).

FIG. 4b shows a cross section of the exhaust nozzle 12 and secondary air passage 9 at stream position B (i.e., as taken along the line ‘B’) of FIG. 3. The core exhaust passage 7 and the secondary air passage 9 are shown transitioning from a round to rectangular shape.

FIG. 4c shows a cross section of the exhaust nozzle 12 and secondary air passage 9 at stream position C (i.e., as taken along the line ‘C’) of FIG. 3. The core exhaust passage 7 and the secondary air passage 9 have substantially transitioned to a rectangular shape as shown. The transition in shape may be rapid or gradual, and the changes and location of stream positions A-C are illustrative only, other transitions are equally envisioned.

FIG. 4d shows a cross section of the exhaust nozzle 12, plurality of lobes 50, injected secondary air 5, auxiliary air outlet 70, ejector shroud 16 and core exhaust passage 7 at stream position D (i.e., as taken along the line ‘D’) of FIG. 3. The plurality of lobes 50 are on the opposite side of the shroud outlet 18 than the adjacent surface 60. The mixing of the core and secondary flows forced by the lobes 50 along with less or no mixing on the side closest to the adjacent surface 60 (as shown, the upper portion is closest and the lower portion is farthest from the adjacent surface 60) urges flow downward away from the adjacent surface 60. The transition from a circular to rectangular exhaust duct with passive mixing on the top and sides of the rectangular exit and a lobed mixer on the bottom side provide a level of mixing but mainly function to turn the flow down so that it is less likely to impinge on the cowling and flaps aft of the exhaust system.

While each of the lobes 50 shown in FIG. 4d are represented as being symmetric, the lobe may asymmetric themselves or heterogeneous with respect to the other of the plurality of lobes 50.

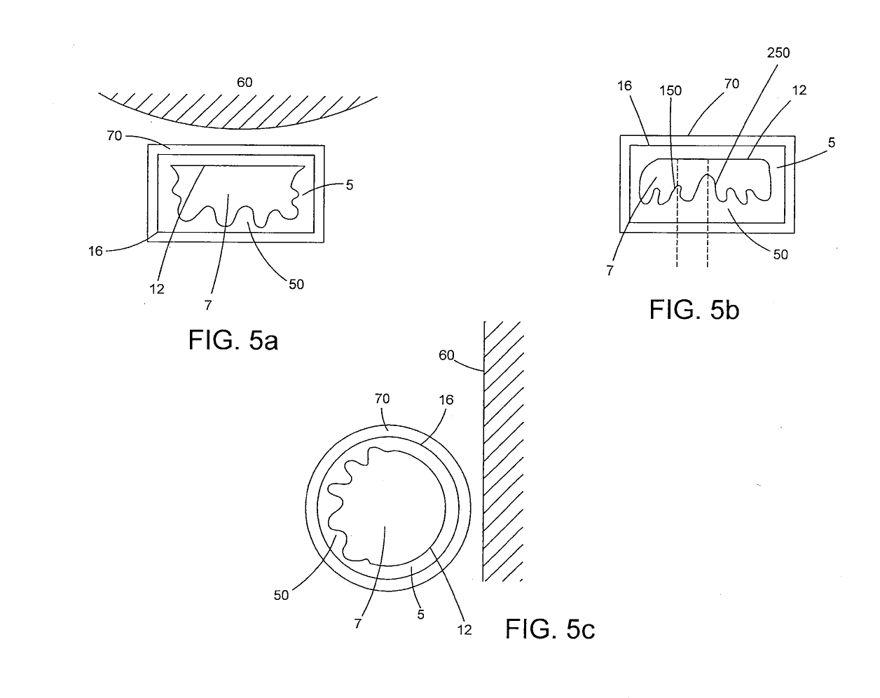

FIG. 5a-5c illustrate other arrangements of the lobes 50 envisioned for the disclosed subject matter. FIG. 5a shows the plurality of forced mixing lobes 50 distributed on the three regions (right side, bottom side and left side) farthest from the adjacent surface 60. FIG. 5b shows the same stream position however with the plurality of lobes 50 being heterogeneous and some of the lobes 50, for example lobe 150, are asymmetrical while other lobes for example lobe 250 is symmetric. FIG. 5c illustrates a round shroud outlet in which the plurality of lobes 50 are located on the hemisphere farthest from the vertical adjacent surface 60 (for example the side of a fuselage or a vertical tail).

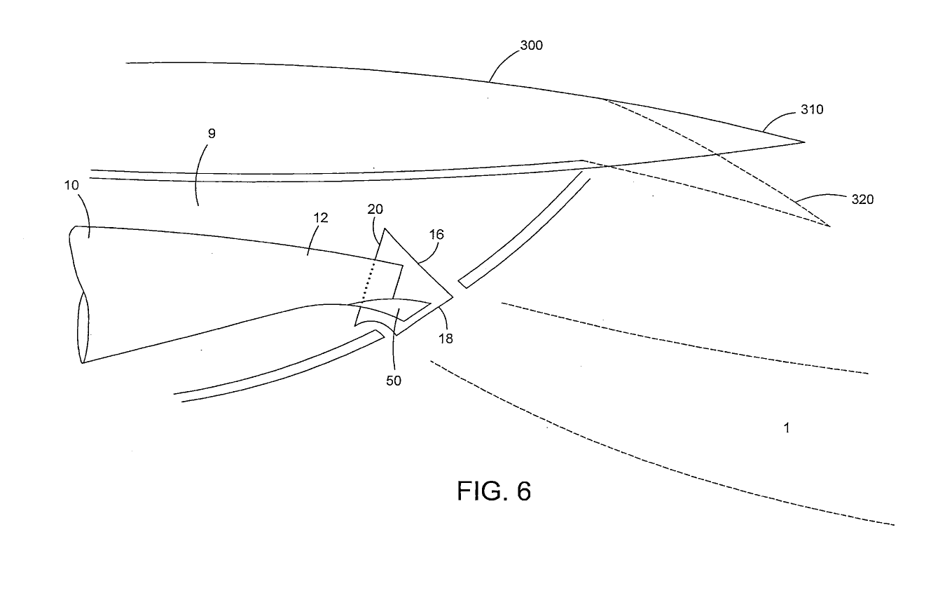

FIG. 6 illustrates an embodiment wherein the exhaust system is under a wing 300 and the exhaust plume 1 is urged away from scrubbing the trailing edge 310 of the wing 300 and flaps/control surface 320.

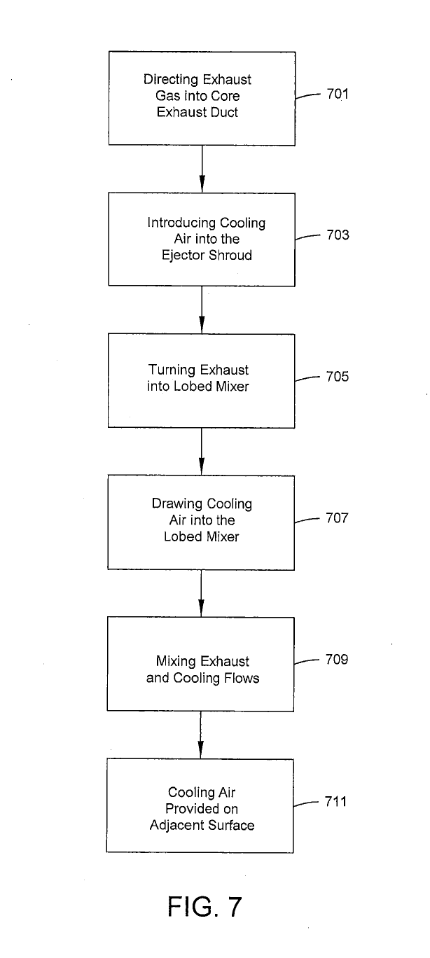

FIG. 7 is a flow chart describing the operation of the exhaust system for turning the flow away from adjacent surfaces on the aircraft. The exhaust gas exits turbine engine 10 along engine axis into the core exhaust duct and is directed by the duct into the exhaust nozzle 12 and ejector shroud 16 as shown in Block 701. The exhaust duct transitions from round to rectangular prior to the start of the lobed mixer 50 and terminates at an optimum point inside of the ejector (giving the best combination of flow turning and mixing).

As shown in Block 703, cooling air from scoops or compartments is captured at the ejector inlets 20, and introduced into the ejector shroud 16. The presence of the high velocity exhaust gas inside the ejector “pulls” the cool air from inside the nacelle or other compartment whereby it forms a thick layer of cool air along the ejector walls and provides significant cooling to the walls. The ejector is shaped to encourage the cool air to remain attached to and flow along the walls. Three sides of the exhaust duct are formed to provide this cooling effect, and as they control the amount of mixing between the cool air and the exhaust gas, they maintain a thick layer of cool air against a desired surface (in this case the ejector wall). The fourth side of the exhaust nozzle 12 forms a lobed mixer 50. The exhaust gas is turned to follow the passage defined by the walls of the ejector shroud 16 as shown in Block 705 and is forced through the lobed mixer 50 for integration of exhaust gas and cooling air. Likewise the secondary or cooling air from the ejector inlet 20 is drawn into the lobed mixer 50 as shown in Block 707 and exhaust gas exits the ejector and mixes with cooling air and as a result of this, asymmetric mixing is directed away from adjacent surfaces of the aircraft as shown in Block 709. In addition to cooling the exhaust gas this mixing reduces the velocity of the exhaust gas and enhances the turning action. The lobed mixer 50 combines exhaust gas and cooling air in such a way that the exhaust gas and plume are directed towards the lobed mixer 50. As discussed previously, the centerline of the ejector shroud can be curved in such a way so as to augment the tendency of the exhaust gas to move towards the lobed mixer 50 and away from the adjacent surface 60 of the aircraft. The amount of flow turning in the device may be controlled by the geometry of the components to give the best balance of turning (with a reduction in heat damage to aircraft parts in close proximity) with minimum impact to performance.

In addition, the cooling air not mixed with the core exhaust gas maybe released to form a layer along both sides of the outer wall of the shroud which separates the hot gases from the plume and the adjacent surfaces that bound or are typically in the path of the plume if not redirected as shown in Block 711.

There are several mixing enhancement features included in this subject matter to facilitate enhancing shearing and mixing between primary nozzle exhaust and ambient air flows. The exhaust nozzle 12 exit facilitates enhances mixing of ambient cooling air and exhaust gases discharged from core engine using chevron-shaped extensions of exhaust nozzle. In one embodiment, each chevron-shaped extension is cup- or spoon-shaped and includes a concave surface that faces inwardly towards the hot primary nozzle exhaust flow.

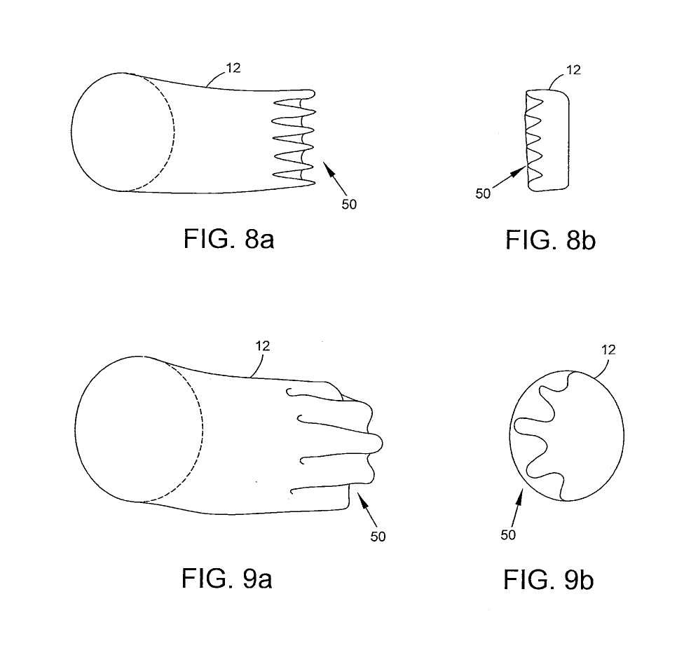

Referring to FIGS. 8a and 8b, the core exhaust nozzle 12 exit is substantially rectangular in cross-section and facilitates enhances mixing of ambient cooling air and exhaust gases discharged from core engine via lobes 50 or (corrugated surfaces) of primary nozzle 12. In this embodiment, each lobe 50 or corrugation is aligned such that the axis of corrugation extends substantially in the same direction as that of the hot primary nozzle exhaust flow.

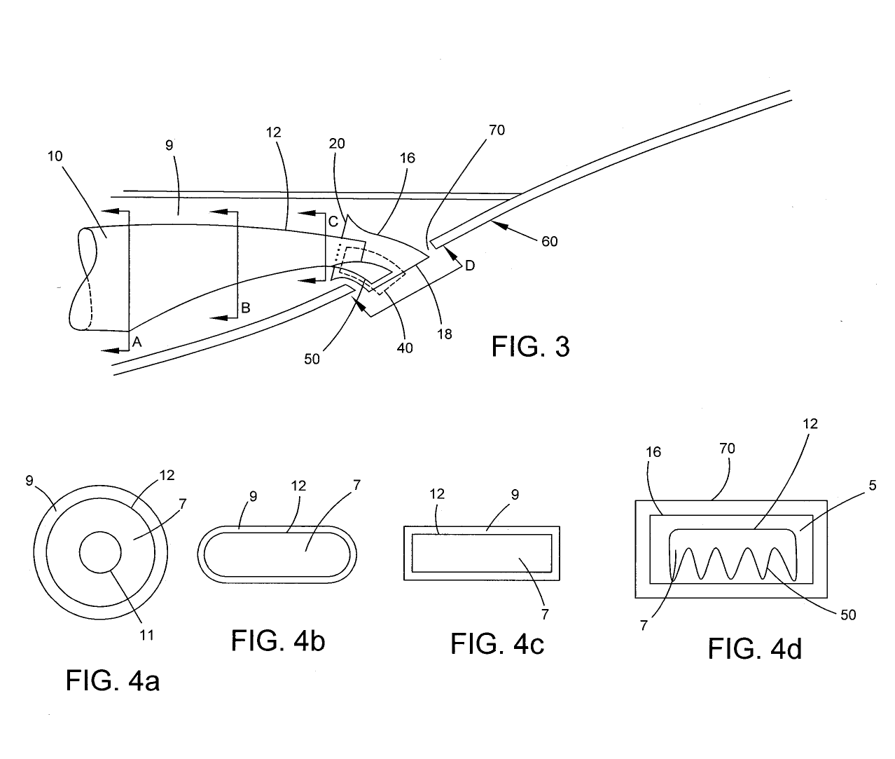

However, the enhanced or forced mixing may be accomplished with or without the use of corrugations and regardless of the cross-sectional shape of the nozzle. For example, in the exemplary embodiment illustrated in FIGS. 9a and 9b, exhaust nozzle 12 has a substantially circular cross sectional profile and includes a plurality of lobes 50.

Likewise the use of a surface disruption such as those chosen from the group consisting of wedges, wings, vanes, teeth, channels, corrugations and ridges may also be used within the ejector to provide the asymmetric mixing that cools and urges the exhaust plume away from aircraft surfaces. Wedges, wings, vanes, teeth, channels, corrugations and ridges all extend into or away from air flow within the ejector shroud thus modifying a directional component of the motion of the air flow within the ejector.

The disclosed exhaust system may also be tailored for use as an IR suppression device. Internal cooling air supply passages (secondary air) may be modulated using valves to control the area of the secondary air passage to provide a variable IR suppression system that provides a high level of suppression when desired or minimal suppression for enhanced aero performance (etc. range, speed, etc.). Referring to FIG. 2, a portion of the ambient air is channeled through the inlet 20 and to the lobes 50, during operation, wherein remaining air entering through inlet 20 on the top portion of the ejector provides a layer of cooling air to facilitate cooling aft portions of ejectors inner surfaces for example the inner surface of the shroud 16, which may be visible through the exhaust shroud outlet 18. Accordingly the lobes 50 facilitate reducing an operating temperature of exhaust flow path surfaces. Accordingly, the exhaust system mitigates the operating temperature of engine exhaust through exhaust system, thus suppressing the infrared signature generated by core engines.

As described above, having the lobes 50 on one portion causes the high velocity exhaust gas to mix with the lower velocity cooling air to influence the plume to mix out quicker than with a stock tailpipe while also drawing the plume away from the protected surface of the aircraft. The exhaust system keeps a layer of cooling air on the exhaust duct thereby providing cooler “visible” exhaust surfaces, thus minimizing damage and reducing heat signature of these surface.

The above-described gas turbine engine assemblies are cost-effective and highly reliable. Each assembly includes an exhaust assembly that facilitates suppressing an infrared signature generated by the core engines. Moreover, in the exemplary embodiment, the exhaust assembly initially turns and accelerates the exhaust prior to mixing the exhaust with an ambient airflow. Additional cooling air facilitates cooling flow path surfaces that are visible through the exhaust assembly discharge. As a result, the exhaust system assembly facilitates suppressing an infrared signature of the engine in a cost-effective and reliable manner.

Although examples are illustrated and described herein, embodiments are nevertheless not limited to the details shown, since various modifications and structural changes may be made therein by those of ordinary skill within the scope and range of equivalents of the claims.

What we claim is:

1. An exhaust system for the protection of an adjacent surface, the exhaust system comprising:
an ejector, the ejector including an engine exhaust nozzle;
an ejector inlet;
an ejector shroud;
a shroud outlet, the shroud outlet being in fluid communication with the atmosphere, and wherein the adjacent surface partially bounds a region proximate to and downstream of the shroud outlet; and
a plurality of forced mixing lobes extending from the engine exhaust nozzle within a region spaced apart from the adjacent surface such that the distribution of lobes is asymmetric in the cross section of the ejector shroud proximate the shroud outlet.

2. The system of claim 1, wherein a region of the shroud outlet closest to the adjacent surface is free from the plurality of lobes.

3. The system of claim 1 further comprising an axillary outlet positioned between the shroud outlet and the adjacent surface.

4. The system of claim 1, wherein a fluid path defined by the ejector shroud has a centerline that bends away from the adjacent surface.

5. The system of claim 1, wherein a cross section of the shroud outlet is substantially rectangular.

6. The system of claim 1, wherein the plurality of lobes extend from the engine exhaust duct within the ejector shroud.

7. The system of claim 1 wherein each of the plurality of lobes are symmetrically shaped.

8. The system of claim 1 wherein each of the plurality of lobes are asymmetrically shaped.

9. The system of claim 1 wherein the adjacent surface is from the group consisting of a nacelle, fuselage, wing, flap and tail.

10. The system of claim 1, wherein the cross section of the ejector shroud proximate the shroud outlet is rectangular and the region spaced apart from the adjacent surface is the side of the rectangle farthest from the adjacent surface, and wherein the side of the rectangle nearer to the adjacent surface is free from the plurality of lobes, and wherein the plurality of lobes extends from the exhaust nozzle to approximately the shroud outlet.

11. A turbine engine core exhaust system comprising:
a core exhaust duct,
a duct defining a passage having an upstream end, a downstream end, a first portion and a second portion; the upstream end being proximate to the core exhaust duct and defining a secondary air inlet; the first and second portions being proximate to the downstream end;
a surface disruption in an interior of the first portion extending into the passage towards the second portion, the second portion being free of the surface disruption.

12. The system of claim 11, wherein the surface disruption is from the group consisting of lobes, wedges, wings, vanes, teeth, channels, corrugations and ridges.

13. The system of claim 11 further comprising an axillary outlet positioned between the duct and the adjacent surface.

14. The system of claim 11, further comprising an adjacent surface downstream of the downstream end and proximate the second portion.

15. The system of claim 11, wherein a cross section of the duct at the downstream end is substantially rectangular.

16. The system of claim 11 wherein the adjacent surface is from the group consisting of a nacelle, fuselage, wing, flap and tail.

17. A method of bending an exhaust flow away from an adjacent surface, comprising:
providing a core exhaust flow within a passage, the passage having one side closer to the adjacent surface than an other side of the passage;
providing a secondary flow between the other side of the passage and the core exhaust flow, wherein the core exhaust flow has a higher velocity than the secondary flow;
reducing the velocity of the core exhaust flow proximate the other side by mixing the core exhaust flow and the secondary flow within the passage proximate the other side of the passage; and,
maintaining the velocity of the core exhaust flow proximate the one side greater than the reduced velocity thereby bending the exhaust flow away from the adjacent surface.

18. The method of claim 17, further comprising providing the secondary flow between the one side of the passage and the core exhaust flow and minimizing the mixing of the secondary flow and the core exhaust flow proximate the one side.

19. The method of claim 17, wherein the passage is substantially rectangular.

20. The method of claim 17, wherein the adjacent surface is from the group consisting of a nacelle, fuselage, wing, flap and tail.

21. An exhaust system for the protection of an adjacent surface, the exhaust system having an ejector, the ejector including an engine exhaust nozzle, an ejector inlet, an ejector shroud and a shroud outlet, the shroud outlet being in fluid communication with the atmosphere, wherein the adjacent surface partially bounds a region proximate and downstream of the shroud outlet, the improvement comprising a plurality of forced mixing lobes extending from the engine exhaust nozzle within a region spaced apart from the adjacent surface such that the distribution of lobes is asymmetric in the cross section of the ejector shroud proximate the shroud outlet.
